(19) United States
(12) Patent Application Publication
(10) Pub. No.: US 2013/0120652 A1
(43) Pub. Date: May 16, 2013

(54) METHOD AND APPARATUS FOR EVALUATING TIME DELAY OF MOBILE VIDEO SERVICE

(71) Applicant: Huawei Technologies Co., Ltd., Shenzhen (CN)

(72) Inventor: Hongen WANG, Shenzhen (CN)

(73) Assignee: HUAWEI TECHNOLOGIES CO., LTD., Shenzhen (CN)

(21) Appl. No.: 13/727,310

(22) Filed: Dec. 26, 2012

Related U.S. Application Data
(63) Continuation of application No. PCT/CN2011/073212, filed on Apr. 23, 2011.

(30) Foreign Application Priority Data
Jun. 25, 2010 (CN) 201010213387.0

(51) Int. Cl. H04N 5/06

(52) U.S. Cl. CPC H04N 5/06
USPC 348/500

(57) ABSTRACT

Embodiments of the invention provide method and apparatus for evaluating a time delay in a video service. The method includes: the data packet in a first collection point is matched with the data packet in a second collection point, wherein, the first collection point and/or the second point divides the transmission path of the service flow of the data packet into at least two segments; if the data packet in the first collection point and the data packet in the second collection point are matched, then the time delay in the service flow of the data packet between the first and the second collection point is calculated. By matching the data packets in the collection points, these embodiments can evaluate the distribution situation of the time delay in the video service in each network segment, and precisely locate the network segment or network element in which the time delay occurs.

### CROSS-REFERENCE TO RELATED APPLICATIONS

This application is a continuation of International Patent Application No. PCT/CN2011/073212, filed on Apr. 23, 2011, which claims priority to Chinese Patent Application No. 201010213387.0, filed on Jun. 25, 2010, both of which are hereby incorporated by reference in their entireties.

### FIELD OF THE INVENTION

The present invention relates to 3G communications field, and more particularly to a method and an apparatus for evaluating time delay in a mobile video service.

### BACKGROUND OF THE INVENTION

With the commercialization of the third-generation (3G) mobile communications technology, video service, such as the mobile video service, has been rapidly developed. Since video time delay is also one of the most important user-experience indices of the mobile video service, it is needed to evaluate the video time delay during course of development, testing and network optimization of the mobile video service system.

According to one of the related art discloses an artificial eye-measurement method for evaluating time delay in the mobile video. Once the test subject (a living human being, for example) makes a certain movement (such as waving an arm), the transmitting end collects a corresponding image of this movement and transmits the image via the network to a receiving end; through eye-measurement, the testing personnel uses a stopwatch to record time Ts at which the image is collected at the transmitting end; while the image is being displayed at the receiving end, time Te at which the image is displayed is recorded. The time difference between time Te and time Ts is the time delay for transmitting the mobile video for once. Transmission time delay in the mobile video service can be evaluated by performing several rounds of measurements and averaging the results.

Since the testing personnel measures time for collecting and displaying images by eyes, the method provided by related art A is inferior in precision. Moreover, the method is only capable of evaluating end-to-end time delays, but is unable to evaluate the transmission time delay distribution of the mobile video service at each network segment or node.

Another method for evaluating time delay in a mobile video as provided by another related art is carried out with the help of dedicated video analysis software. In such a method, the dedicated video analysis software is deployed at the interface between the transmitting end and the receiving end of the system to record the time at which a designated video data packet is transmitted via a network from the transmitting end and the time at which it is received by the receiving end, and to calculate the time difference between the two times, whereby it is possible to evaluate the transmission time delay in the video.

Similar to the method provided by the aforementioned the one related art, the method provided by another related art is only capable of evaluating end-to-end time delays, but is unable to evaluate the transmission time delay distribution of the mobile video service at each network segment or node. Moreover, since it is required to buy the dedicated video analysis software, the method is relatively high in cost, and it usually takes lengthy time to construct the environment and prepare the data packet.

### SUMMARY OF THE INVENTION

Embodiments of the present invention provide a method and an apparatus for evaluating the time delay in a video service, and aim to solve the technical problem in the related art for the inability to evaluate the distribution of the transmission time delay in the mobile video service over each network segment or node.

Embodiments of the present invention provide a method for evaluating time delay in a video service, which method comprises: matching a data packet in a first collection point with a data packet in a second collection point, the first collection point and/or the second collection point dividing a transmission path of a service flow containing the data packet into at least two segments; and calculating, if the data packet in the first collection point and the data packet in the second collection point are matched, time delay in the service flow of the data packet between the first collection point and the second collection point.

Embodiments of the present invention provide an apparatus for evaluating time delay in a video service, which apparatus comprises: a matching module, for matching a data packet in a first collection point with a data packet in a second collection point, the first collection point and/or the second collection point dividing a transmission path of a service flow containing the data packet into at least two segments; and a time delay calculating module, for calculating time delay in the service flow containing the data packet between the first collection point and the second collection point, when a matching result of the matching module shows that the data packet in the first collection point and the data packet in the second collection point are matched.

Embodiments of the present invention match data packets collected at random collection points with one another, and calculate the time delay in these data packets between the collection points after these collected data packets can be matched with one another. In comparison with the related art, since matching is carried out for data packets in the collection points (rather than at the receiving end or transmitting end), it is possible to evaluate the time delay distribution of the video service over divided network segments, and to precisely locate the network segment or network element at which the time delay occurs.

### BRIEF DESCRIPTION OF DRAWINGS

To make clearer the explanation of technical solutions of the embodiments of the present invention or of the related art, drawings needed in the description of the embodiments are briefly illustrated below. Apparently, the drawings illustrated below are merely directed to some embodiments of the present invention, and it is possible for persons ordinarily skilled in the art to deduce other drawings from these drawings without creative effort.

FIG. 1 is a flowchart exemplarily illustrating the method for evaluating time delay in a video service provided by Embodiment 1 of the present invention;

FIG. 2 is a flowchart exemplarily illustrating the method for evaluating time delay in a video service provided by Embodiment 2 of the present invention;

FIG. 3 is a flowchart exemplarily illustrating the method for evaluating time delay in a video service provided by Embodiment 3 of the present invention;

FIG. 4 is a flowchart exemplarily illustrating the method for evaluating time delay in a video service provided by Embodiment 4 of the present invention;

FIG. 5 is a flowchart exemplarily illustrating the method for evaluating time delay in a video service provided by Embodiment 5 of the present invention;

FIG. 6 is a view exemplarily illustrating assignment of subtransaction into transmission-type atomic transaction and processing-type atomic transaction provided by Embodiment 6 of the present invention;

FIG. 7 is a flowchart exemplarily illustrating the method for evaluating time delay in a video service, simplified from Embodiment 5 of the present invention, provided by Embodiment 7 of the present invention;

FIG. 8 is a view exemplarily illustrating the basic logic structure of the apparatus for evaluating time delay in a video service provided by Embodiment 8 of the present invention;

FIG. 9 is a view exemplarily illustrating the basic logic structure of the apparatus for evaluating time delay in video service provided by Embodiment 9 of the present invention;

FIG. 10 is a view exemplarily illustrating the basic logic structure of the apparatus for evaluating time delay in a video service provided by Embodiment 10 of the present invention;

FIG. 11 is a view exemplarily illustrating the basic logic structure of the apparatus for evaluating time delay in a video service provided by Embodiment 11 of the present invention;

FIG. 12 is a view exemplarily illustrating the basic logic structure of the apparatus for evaluating time delay in a video service provided by Embodiment 12 of the present invention;

FIG. 13 is a view exemplarily illustrating the basic logic structure of the apparatus for evaluating time delay in a video service provided by Embodiment 13 of the present invention; and

FIG. 14 is a view exemplarily illustrating the basic logic structure of the apparatus for evaluating time delay in a video service provided by Embodiment 14 of the present invention.

### DETAILED DESCRIPTION OF THE INVENTION

The technical solutions according to the embodiments of the present invention will be clearly and completely described below with reference to the drawings. Apparently, the embodiments as described below are merely partial, rather than entire, embodiments of the present invention. On the basis of the embodiments of the present invention, all other embodiments obtainable by persons ordinarily skilled in the art without creative effort shall all fall within the protection scope of the present invention.

Referring to FIG. 1, which is a flowchart exemplarily illustrating the method for evaluating a time delay in the video service provided by Embodiment 1 of the present invention, the method mainly includes the following steps.

S101. matching a data packet in a first collection point with a data packet in a second collection point.

There may be many nodes in a transmission path over which a service flow (such as a mobile video service flow) is transmitted from an original transmitting end to a final receiving end, and these nodes would perform corresponding processing actions on the service flow at different times. In the embodiments of the present invention, a certain data packet of the service flow that is being transmitted may be intercepted, and this action “interception” can be regarded as “collection” to data. The time at which the data is collected can also be regarded as a “collection point” according to the temporal sequence of the entire end-to-end transmission of the service flow.

To achieve evaluation in segments of a time delay in a service flow (such as a mobile video service flow), the first collection point and/or the second collection point divide(s) a transmission path of the service flow containing the data packet into at least two segments. on the principle whereof, the first collection point and the second collection point do not simultaneously reside at the original transmitting end and final receiving end of the service flow; otherwise it would only be possible to evaluate end-to-end time delay in the service flow.

According to the embodiments of the present invention, the data may be collected either by one node or by different nodes. There are both temporal meaning and spatial meaning between different collection points, and time delay in the service between collection points is sometimes also the time delay among nodes. For instance, supposed there are node (device) 1, node 2 and node 3, and interaction among node 1, node 2 and node 3 is as follow (with the arrows indicating flow directions of the data):
(time T1) node 1→node 2 (time T2)
(time T3) node 2→node 1 (time T4)
(time T5) node 2→node 3 (time T6)
(time T7) node 3→node 2 (time T8)

Time T2, time T3, time T5 and time T8 are all collection points on the same node (node 2), and time delay between collection point S3 (time T3) of the service and collection point S4 (time T4) of the service can be regarded as time delay in the service between the node 2 and the node 1 during the process of “node 2→node 1” from the spatial perspective. When there are different collection points on the same node, temporal sequences are distinguished according to flow directions of the data.

As should be explained, an open source grabbing tool can be used in the embodiments of the present invention to collect the data in the collection points. Since the open source grabbing tool has basic parsing capability enabling to export an XML file from the parsed collection data, only simple document parsing capability is required to realize relevant functions. Accordingly, the cost for evaluation of the time delay is greatly reduced in comparison with the related technology.

S102. calculating, if the data packet in the first collection point and the data packet in the second collection point are matched, the time delay in the service flow containing the data packet between the first collection point and the second collection point.

As previously mentioned, since it is possible to divide the transmission process of the service flow by using the collection points according to the temporal sequence of the service, time delay distribution of the video service at each network segment or network element can be precisely evaluated by calculating the time delay in the data packet between random collection points.

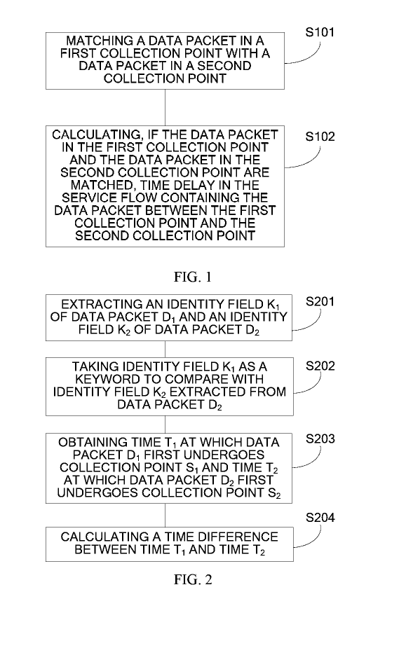

In the embodiments of the present invention, the data packet in the first collection point or the data packet in the second collection point may be a video data packet, an audio data packet or an audio-video mixed data packet. To facilitate explanation, the data packet in the first collection point is referred to as data packet D1, the data packet in the second collection point is referred to as data packet D2, the first collection point is referred to as collection point S1, and the second collection point is referred to as collection point S2. FIG. 2 illustrates the method for evaluating the time delay in the video service with examples of the data packet D1 and the data packet D2, where the data packet D1 and the data packet D2 are both a video data packets, which method mainly includes the following steps.

S201. extracting an identity field K1 of the data packet D1 and an identity field K2 of the data packet D2.

It is supposed in this embodiment that the two collection points S1 and S2 are selected, and that the collection points S1 and S2 are selected at the same node device out of consideration for precision in calculating the time delay. During the transmission process of the service flow, the data packet D1 of the service flow is collected at the collection point S1, the data packet D2 of the service flow is collected at the collection point S2, and the identity field K1 of data packet D1 and the identity field K2 of data packet D2 are extracted.

As should be explained, the selection of collection points is rather flexible, and, in principle, the collection points can be selected as long as they are sufficient to divide the main process of the service or the requirement of evaluation in segments of the time delay is satisfied. The selection of the collection points S1 and S2 at the same node device should not be regarded as restrictive of the present invention.

Since the data packet D1 and the data packet D2 are both the video data packets, it is possible to take certain field of the video data packet as an identity field to uniquely identify a video data packet. For instance, if the data packet D1 and the data packet D2 are both the video data packets supported by the RTP protocol, it is possible to take a Synchronization SouRCe identifier (SSRC) field and a Sequence Number (SN) field as the identity field K1 of the data packet D1 or the identity field K2 of the data packet D2.

S202. taking the identity field K1 of the data packet D1 as a keyword to compare with the identity field K2 of the data packet D2.

If the identity field K1 of the data packet D1 is the same as the identity field K2 of the data packet D2, for instance, the data packet D1 and the data packet D2 are both the video data packets supported by the RTP protocol, if the SSRC field of the data packet D1 is the same as the SSRC field of the data packet D2, and the SN field of the data packet D1 is the same as the SN field of the data packet D2, the data packet D1 and the data packet D2 are matched. Once the data packet D1 and the data packet D2 are matched, it can be considered that essential contents included in the two data packets are the same, that the two data packets have merely undergone different collection points, and that it takes time for different collection points to process the data packets, thus also generating partial time delay.

S203. obtaining time T1 at which the data packet D1 first undergoes collection point S1 and time T2 at which the data packet D2 first undergoes collection point S2.

Since the system records the time at which a data packet undergoes a collection point, it is possible in this embodiment to obtain the time T1 at which the data packet D1 first undergoes collection point S1 and the time T2 at which the data packet D2 first undergoes the collection point S2. As an example of the present invention, it is possible to take a time stamp (TS), marked when the data packet D1 first undergoes the collection point S1, as the time T1 at which the data packet D1 first undergoes the collection point S1, and to take a time stamp, marked when the data packet D2 first undergoes the collection point S2, as the time T2 at which the data packet D2 first undergoes the collection point S2.

S204. calculating a time difference between the time T1 and the time T2.

The time difference between the time T1 and the time T2 is the time delay in the data packet D1 or the data packet D2 transmit from the collection point S1 to the collection point S2.

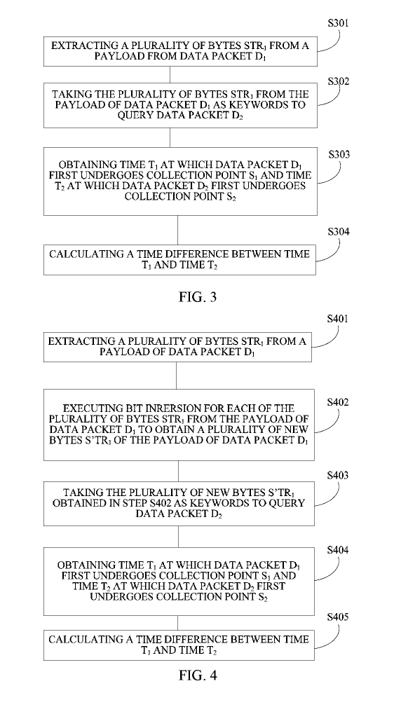

Refer to FIG. 3, which is a flowchart exemplarily illustrating the method for evaluating a time delay in a video service provided by Embodiment 3 of the present invention. Explanation is made in this embodiment with examples of a data packet D1 being a video data packet and a data packet D2 being an audio-video mixed data packet. The method mainly includes the following steps.

S301. extracting a plurality of bytes Str1 from a payload of the data packet D1.

Similar to the embodiment shown in FIG. 2, it is still supposed in this embodiment that the two collection points, the collection point S1 and the collection point S2, are selected, and that the collection point S1 and the collection point S2 can be selected at the same node device out of consideration for precision in calculating a time delay. During the transmission process of the service flow, the data packet D1 of the service flow is collected at the collection point S1, and the data packet D2 of the service flow is collected at the collection point S2.

The difference from the embodiment shown in FIG. 2 is as follows: since the data packet D1 is a video data packet and the data packet D2 is an audio-video mixed data packet, a mechanism of the transmission and a format of transmission of the two embodiments may not be the same. For instance, in this embodiment, an application layer of the data packet D1 may adopt the H.263 protocol, an application layer of the data packet D2 may adopt the H.324M protocol, and it is impossible to match the data packets according to identity fields (such as SSRC+SN).

It is possible in this embodiment to extract the plurality of bytes Str1 from the payload of data packet D1. That how many bytes may be extracted depends upon whether a requirement of matching is satisfied. For instance, if the data packet D1 is supported by the H.263 protocol, it is sufficent to extract an initial six bytes (which are marked as Str1) from the payload of the data packet D1.

S302. taking the plurality of bytes Str1 from the payload of the data packet D1 as keywords to query in the data packet D2.

In this embodiment, for the realization of Steps S301 to S302, it is possible to take the plurality of bytes Str1 of the payload of the data packet D1 as keywords to search in the data packet D2 with a document searching mode by exporting data collected in the collection point S1 (in which the data packet D1 is included) and data collected in the collection point S2 (in which the data packet D2 is included) as a database record file or an eXtendable Mark Language (XML) file. If plural bytes identical with the plurality of bytes Str1 of the payload of the data packet D1 are found in the payload of the data packet D2, the data packet D1 and the data packet D2 are matched.

S303. obtaining time T1 at which the data packet D1 first undergoes the collection point S1 and time T2 at which the data packet D2 first undergoes the collection point S2.

S304. calculating a time difference between the time T1 and the time T2.

Methods for realizing Steps S303 to S304 are the same as those in the embodiment of the present invention illustrated in FIG. 2, and are hence not redundantly described here. The time difference between the time T1 and the time T2 is a time delay in the data packet D1 or the data packet D2 transmit from collection point S1 to collection point S2.

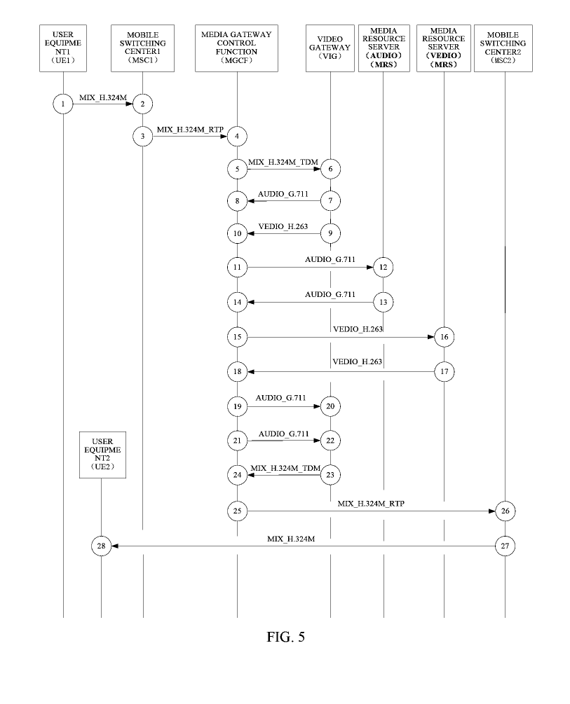

Refer further to FIG. 4, which is a flowchart exemplarily illustrating the method for evaluating a time delay in a video service provided by Embodiment 4 of the present invention. Explanation is made in this embodiment still with examples of the data packet D1 being a video data packet and the data packet D2 being an audio-video mixed data packet. The method mainly includes the following steps.

S401. extracting a plurality of bytes Str1 from a payload of the data packet D1.

S402. executing bit inversion for each of the plurality of bytes Str1 from the payload of the data packet D1 to obtain a plurality of new bytes S'tr1 of the payload of the data packet D1.

S403. taking the plurality of new bytes S'tr1 obtained in Step S402 as keywords to query in the data packet D2.

If plural bytes identical with the plurality of new bytes S'tr1 of the payload of the data packet D1 are found in the payload of the data packet D2, the data packet D1 and data the packet D2 are matched.

S404. obtaining time T1 at which the data packet D1 first undergoes the collection point S1 and time T2 at which the data packet D2 first undergoes the collection point S2.

S405. calculating a time difference between the time T1 and the time T2.

Steps S401, S403, S404 and S405 in this embodiment are substantially the same as those in the embodiment illustrated in FIG. 3, and are hence not redundantly described here.

It is necessary in Step S402 of this embodiment to execute bit inversion for each of the plurality of the bytes Str1 of the payload of the data packet D1 to obtain a plurality of new bytes S'tr1. Executing bit inversion is required because when data is carried via different communication protocols, the same bytes contained in the data may be differently expressed via the different communication protocols, and these same bytes can be matched only after their bit sequences are executed bit inversion reversed beforehand. For instance, byte ce (ce in the hexadecimal system, and expressed as 11001110 in the binary system) in the H.263 protocol is expressed as byte 73 (73 in the hexadecimal system, and expressed as 01110011 in the binary system) in the H.324M protocol, that is to say, the bit sequence in the latter byte are precisely executed bit inversion in sequence to the bit sequence in the former byte.

In this embodiment, it is possible to completely execute bit inversion the positions or sequences of bits of each byte in the plurality of bytes Str1, in the original byte, that is to say, bits 0, 1, 2, 3, 4, 5, 6, 7 of each byte are correspondingly changed to bits 7, 6, 5, 4, 3, 2, 1, 0, to obtain a plurality of the new bytes S'tr1.

In the embodiments according to the present invention as illustrated in FIGS. 1 to 4, it is possible to collect data packets in the packet switch (PS) domain to obtain the data packet D1 in the collection point S1 or the data packet D2 in the collection point S2.

If collection of the data packets in the PS domain to obtain the data packet D1 in the collection point S1 or the data packet D2 in the collection point S2 could still not precisely evaluate the time delay in the video service and locate the network segment or network element in which the time delay occurs, it is possible in the embodiments of the present invention to collect the data packets in the PS domain and the circuit switch (CS) domain to obtain the data packet D1 in the collection point S1 or the data packet D2 in the collection point S2. The data packet D1 or the data packet D2 collected in the PS domain is carried via the IP and be identified by upper layer protocols (such as H.263 or H.324); however, since collection is performed at the narrow band as regards the CS domain, it is necessary to further parse the data packet D1 or the data packet D2 collected in the circuit switch domain collection point, so as to be identified or parsed by the upper layer protocols (such as H.263 or H.324).

In comparison with the one related art, evaluating the time delay in the service by the collection of the data packets in the PS domain and the CS domain has higher precision. In comparison with the another related art, since the collecting tool provided by the embodiments of the present invention may be an open source grabbing tool, automatic analysis can be achieved with the cooperation of few development, and it ist sufficient to use corresponding collecting equipment even in the case of narrow-band collection point, production cost is relatively low.

As should be explained, in the embodiments of the present invention as illustrated in FIGS. 1 to 4, although the two collection points are used to explain the technical solution of the present invention, the present invention is not restricted to evaluating the time delay in the video service while undergoing two collection points, and the present invention is entirely capable of being applied to the circumstance of more collection points. For instance, when a plurality of collection points are selected, the method for evaluating the time delay in the video service at any two collection points may be as described in the embodiments of the present invention illustrated in FIGS. 1 to 4; furthermore, it is possible to make statistics about the time delay in the service flow (a video service flow or an audio-video mixed service flow, for example) containing the data packet D1 or the data packet D2 between the collection points, so as to obtain the distribution situation of the time delay in the entire video service on the network segments divided by random collection points, for instance, the maximum value, minimum value and average value of the time delay in the video service at each network segment.

As can be known from the aforementioned embodiments of the present invention, since it is possible to use an open source grabbing tool to collect data in the collection points, and the open source grabbing tool has basic parsing capability capable of exporting an XML file from the parsed collected data, only relatively simple text parsing capability is required to realize the relevant functions; accordingly, production cost is greatly reduced in comparison with the related arts; moreover, by matching the data packets in the collection points (not only the receiving end or the transmitting end), it is possible to evaluate the distribution situation of the time delay in the video service in each network segment, and to precisely locate the network segment or network element in which the time delay occurs.

Refer to FIG. 5, which is a flowchart exemplarily illustrating the method for evaluating a time delay in a video service provided by Embodiment 5 of the present invention. This embodiment is directed to the scenario in which the present invention is applied to a video conference, wherein service data packets include an audio data packet, a video data packet or an audio-video mixed data packet, which are explained in detail below.

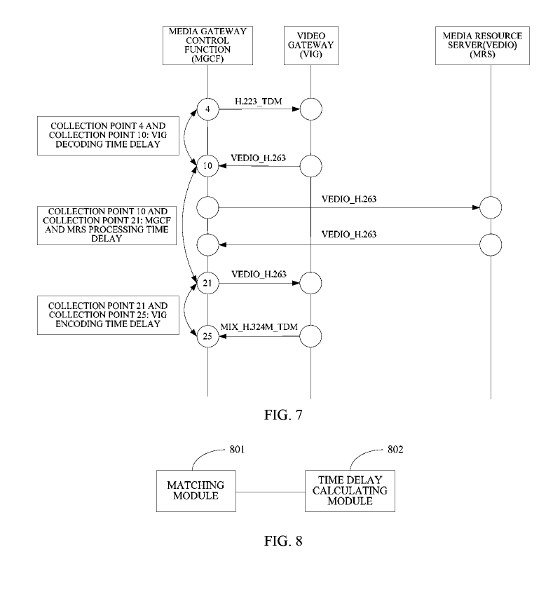

In this embodiment, it is possible to define the time, at which the service is processed at a node device, as an atomic point according to temporal sequence of the service. Moreover, in order to facilitate explanation, the atomic points may be numbered, as shown in FIG. 7, the numbers of the atomic points are as 1 to 28 and total number of the atomic points is 28.

In FIG. 5 of the embodiment, the attributes of the data packets interacting between atomic points are expressed by characters between short horizontal lines. The attributes of the data packets includes three sections: the first section explains the contents including video (expressed as VIDEO), audio (expressed as AUDIO) and audio-video mixing (expressed as MIX); the second section explains upper layer protocols including G.711, H.263 and H.324M, etc.; and the third section explains lower layer protocols including TDM and RTP etc. (the third section may be omitted when data packets interacts between UE and MSC, where the third section is not marked as TDM among other node devices, the third section is RTP by default). For example, the attribute of a data packet MIX_H.324M_TDM interacting between atomic points 5 and 6 is as: an H.324M audio-video mixed data packet carried by the lower layer protocol of TDM.

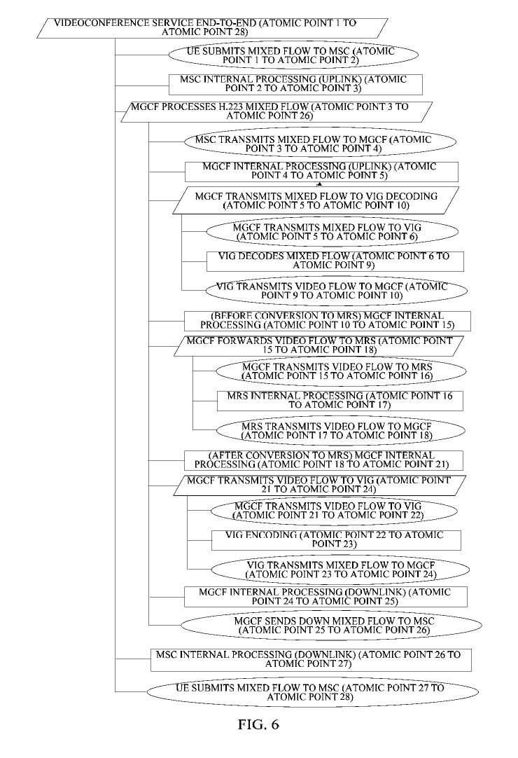

In accordance with the temporal sequence and the numbering of atomic points shown in FIG. 5, it is possible to divide the entire end-to-end service in an example into a plurality of subtransactions, which can be classified as transmission-type atomic transactions and processing-type atomic transactions, as shown in FIG. 6. In FIG. 6, parallelogrammic blocks (“ [symbol] ”) represent transactions, rectangular blocks (“ [symbol] ”) represent processing-type atomic transactions, and elliptical blocks (“ [symbol] ”) represent transmission-type atomic transactions. It is possible, by calculating the time delay in each transaction, to evaluate the distribution of the time delay in the entire end-to-end service, so as to observe the proportion of the time delay in each transaction in the end-to-end video service, and to finally determine transactions with larger time delays and network segments the transactions with larger time with larger time delays involvs therein or network elements the transactions with larger time with larger time delays involvs therein.

As should be explained, data is collected not in each atomic point. It is possible to analyze the objective to be achieved by the time delay evaluation, to select several atomic points to separate the entire transmission path into a plurality of large network segments. If necessary, several atomic points are further selected between the large network segments to further separate the network segments. In this embodiment, considering that atomic points 4, 10, 21 and 25 are all located on the same node device (MGCF) so that calculation of the time delay is relatively precise, and that these four atomic points are enough to segment the main process of the service, the atomic points 4, 10, 21 and 25 can be used as the collection points of data, whereby FIG. 5 is simplified as FIG. 7. As comprehension of the person skilled in the art, the selection of the collection points can be performed on demand, and selection of the collection points in FIG. 7 is merely exemplary of the present invention rather than restrictive to the technical solution of the present invention.

It may be supposed that a number of image frames has already been transmitted in a video service system, and that data packets D4, D10, D21 and D25 are respectively collected in collection point 4 (hereinafter referred to as S4), collection point 10 (hereinafter referred to as S10), collection point 21 (hereinafter referred to as S21), and collection point 25 (hereinafter referred to as S25). 100791 In this embodiment, the process of matching the data packet collected in S10 and the data packet collected S21 includes the following steps.

S711. extracting an identity field of the data packet D10—for instance, SSRC field+SN field of the data packet D10 are extracted, and the SSRC field+SN field of the data packet D10 are marked as K10;

S712. querying in the data packets collected in S21, and comparing whether the identity field of the data packet D10 is identical with the identity field of the data packet D21, namely comparing whether the SSRC field of the data packet D10 is identical with the SSRC field of the data packet D21, and whether the SN field of the data packet D10 is identical with the SN field of the data packet D21.

Since the data packet D10 collected in S10 and the data packet D21 collected in S21 are both video data packets (VIDEO_H.263), it is only needed to search in the data packets collected in S21 to query whether there is a data packet having the same identity field as the identity field (SSRC field+SN field) of the data packet D10; if there is the data packet having the same identity field as the identity field (SSRC field+SN field) of the data packet D10, the data packet D10 matches with the data packet D21.

In this embodiment, the process of matching the data packets collected in S10 and S4 includes the following steps.

S721. extracting a plurality of bytes from the payload of the data packet D10, for instance, extracting the first six bytes 00 00 81 ce 08 0a (hexadecimal system) from the payload of the data packet D10, and marking the plurality of bytes from the payload of the data packet D10 as Str10;

S722. querying in the data packets collected in S4, and searching for any data packet having the first six bytes as 00 00 81 ce 08 0a (hexadecimal system) of the payload thereof.

In this embodiment, since the data packet D10 collected in S10 is a video data packet (VIDEO_H.263), whereas the data packet D4 collected in S4 is an audio-video mixed data packet (MIX_H.324M_TDM), it is impossible to match the data packet D4 and the data packet D10 by comparing the identity field of the data packet D10 and the identity field of the data packet D4, and it is only possible to search for the data packets collected in S4 to find whether there is any data packet having the first six bytes as 00 00 81 ce 08 0a (hexadecimal system) of the payload thereof, if there is a data packet having the first six bytes as 00 00 81 ce 08 0a of the payload (for instance, if the first six bytes of the data packet D4 are 00 00 81 ce 08 0a), the data packet D10 matches with the data packet D4. 100871 During specific implementation of S722, it is possible to export the collected data as database record or an XML file and the search of S722 can be done by using the document searching mode.

As should be explained, in this embodiment S711 and S712 may as well be performed at the same time; that is to say, the identity field of the data packet D10 and the plurality of bytes from the payload of the data packet D10 are extracted at the same time, whereto the present invention makes no restriction.

As should be further explained, in another embodiment of the present invention, when data is carried via different communication protocols, the same bytes contained in the data may be differently expressed via the different communication protocols, and these same bytes can be matched only after their bit sequences are executed inversion beforehand. For instance, byte ce (ce in the hexadecimal system, and expressed as 11001110 in the binary system) in the H.263 protocol is expressed as byte 73 (73 in the hexadecimal system, and expressed as 01110011 in the binary system) in the H.324M protocol, that is to say, the bit sequence in the latter byte are precisely reverse in sequence to the bit sequence in the former byte.

Accordingly, in S721 and S722 of the above embodiment it is necessary, after extracting a plurality of bytes of the payload of the data packet D10, to further execute bit inversion for the first six bytes 00 00 81 ce 08 0a of the payload of the data packet D10 to obtain new bytes 00 00 81 73 10 50 (hexadecimal system), to query in the data packets collected in S4 to search for data packets having the first six bytes as 00 00 81 73 10 50 (hexadecimal system) of the payload thereof.

The process of matching data packets collected in S10 and S25 is similar to the process of matching data packets collected in S10 and S4, and is hence not redundantly described here.

If the data packets D4, D10, D21 and D25 collected in S4, S10, S21 and S25 can be matched, a time T4 at which the data packet D4 first undergoes S4, a time T10 at which the data packet D10 first undergoes S10, a time T21 at which the data packet D21 first undergoes S21, and a time T25 at which the data packet D25 first undergoes S25 are obtained (the time stamp, when each data packet first undergoes the corresponding collection point, is marked as the time at which the data packet first undergoes the corresponding collection point), and the time difference between any times is calculated to obtain the time delay in the data packet between any two collection points. Furthermore, it is possible to make statistics the time delays among the various collection points to evaluate the distribution of the time delay in the video service at the network segments.

Refer to FIG. 8, which is a view exemplarily illustrating the basic logic structure of the apparatus for evaluating time delay in the video service provided by Embodiment 8 of the present invention. To facilitate explanation, shown are only those sections that are relevant to the embodiments of the present invention. Functional modules included in the evaluating apparatus may be software modules, hardware modules or modules incorporating software with hardware. The apparatus includes a matching module 801 and a time delay calculating module 802.

The matching module 801 is configured to match a data packet in a first collection point with a data packet in a second collection point, wherein the first collection point and/or the second collection point divide(s) a transmission path of a service flow containing these data packets into at least two segments.

The time delay calculating module 802 is configured to calculate the time delay in the service flow containing the data packets between the first collection point and the second collection point, when a matching result of the matching module 801 shows that the data packet in the first collection point and the data packet in the second collection point matches.

In this embodiment, the data packet in the first collection point or the data packet in the second collection point may be a video data packet, an audio data packet, or an audio-video mixed data packet.

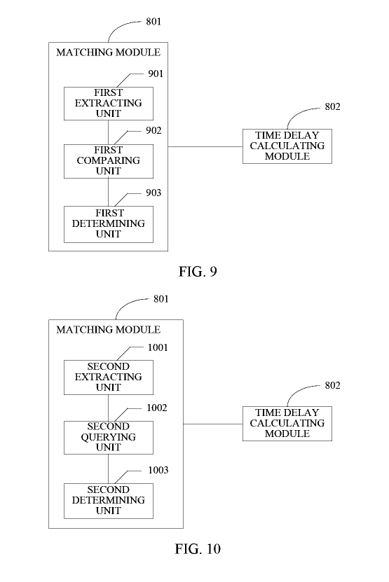

The matching module 801 exemplarily illustrated in FIG. 8 may further include a first extracting unit 901, a first comparing unit 902 and a first determining unit 903 in the apparatus for evaluating the time delay in the video service provided by Embodiment 9 of the present invention as shown in FIG. 9.

The first extracting unit 901 is configured to extract an identity field K1 of the video data packet in the first collection point.

The first comparing unit 902 is configured to take the identity field K1 extracted by the first extracting unit 111 as a keyword to compare with an identity field K2 of the video data packet in the second collection point.

The first determining unit 903 is configured to determine that the video data packet in the first collection point and the video data packet in the second collection point matches if the identity field K1 is identical with the identity field K2 after comparison by the first comparing unit 902.

The matching module 801 exemplarily illustrated in FIG. 8 may further include a second extracting unit 1001, a second comparing unit 1002 and a second determining unit 1003 in the apparatus for evaluating the time delay in the video service provided by Embodiment 10 of the present invention as shown in FIG. 10.

The second extracting unit 1001 is configured to extract a plurality of bytes Str1 from a payload of the video data packet in the first collection point.

The second querying unit 1002 is configured to take the plurality of bytes Str1 of the payload of the video data packet in the first collection point extracted by the second extracting unit 1001 as keywords to query in the audio-video mixed data packet in the second collection point.

The second determining unit 1003 is configured to determine that the video data packet in the first collection point and the audio-video mixed data packet in the second collection point matches if the second querying unit 1002 queries in a payload of the audio-video mixed data packet in the second collection point that there are a plurality of bytes identical with the plurality of bytes Str1 of the payload of the video data packet in the first collection point.

The matching module 801 exemplarily illustrated in FIG. 8 or FIG. 10 may further include a converting unit 1101 in the apparatus for evaluating the time delay in the video service provided by Embodiment 11 of the present invention as shown in FIG. 11.

The converting unit 1101 is configured to execute bit inversion for each of the plurality of bytes of the payload of the video data packet in the first collection point extracted by the second extracting unit 1001 to obtain a plurality of new bytes S'tr1. In this case, the second querying unit 1002 is configured to take the plurality of new bytes S'tr1 obtained by the converting unit 1101 as keywords to query in the audio-video mixed data packet in the second collection point and the video data packet in the first collection point and the audio-video mixed data packet in the second collection point are determined as matched if it is queried in a payload of the audio-video mixed data packet in the second collection point that there are a plurality of bytes identical with the plurality of new bytes S'tr1 of the payload of the video data packet in the first collection point.

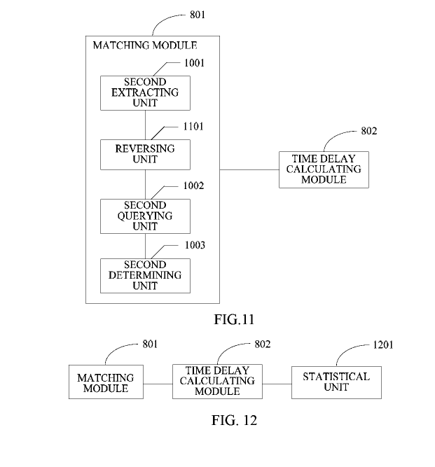

The apparatuses for evaluating the time delay in the video service exemplarily illustrated in FIGS. 8-11 may further include a statistical module 1201. In the apparatus for evaluating the time delay in the video service provided by Embodiment 12 of the present invention as shown in FIG. 12, the statistical module 1201 is configured to make statistics about the time delay in the service flow containing the data packet in the first collection point or the second collection point between each of the collection points, so as to obtain the distribution of the time delay in the entire video service on the network segments divided by random collection points, for instance, the maximum value, minimum value and average value of the time delay in the video service at each network segment.

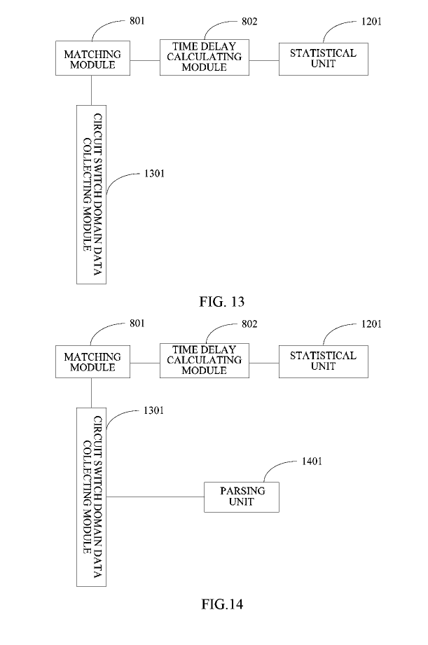

The apparatuses for evaluating the time delay in the video service exemplarily illustrated in FIGS. 8-11 may further include a circuit switch domain data collecting module 1301. In the apparatus for evaluating the time delay in the video service provided by Embodiment 13 of the present invention as shown in FIG. 13, the circuit switch domain data collecting module 1301 is configured to collect data in a circuit switch domain collection point to obtain the data packet in the first collection point or the data packet in the second collection point.

The apparatus for evaluating the time delay in the video service exemplarily illustrated in FIG. 13 may further a parsing module 1401. In the apparatus for evaluating the time delay in the video service provided by Embodiment 14 of the present invention as shown in FIG. 14, the parsing module 1401 is configured to parse the data packet collected by the circuit switch domain data collecting module 1301 in the circuit switch domain collection point to obtain the data packet in the first collection point or the data packet in the second collection point identified by an upper layer protocol.

As should be explained, since information interaction among and execution processes of the various modules/units of the aforementioned apparatuses are based on the same principles as the method embodiments of the present invention, the technical effects achieved thereby are also identical with those achievable by the method embodiments of the present invention. Reference can be made to the foregoing method embodiments for their specific contents, while no repetition is made here.

As comprehensible to persons ordinarily skilled in the art, the entire or partial steps in the various methods of the foregoing embodiments can be realized by a program that instructs relevant hardware, and the program can be stored in a computer-readable storage medium, which may include a read-only memory (ROM), a random access memory (RAM), a magnetic disk or an optical disk.

The methods and apparatuses for evaluating the time delay in the mobile video provided by the embodiments of the present invention are described in detail above, and concrete examples are used in this paper to enunciate the principles and embodiments of the present invention. The above explanations of the embodiments are merely meant to help understand the methods of the present invention and essential principles thereof. To persons ordinarily skilled in the art, there may be variations both in terms of specific embodiments and scopes of application without departing from the principles of the present invention. In summary, contents of the Description shall not be understood as restrictive of the present invention.

What is claimed is:

1. A method for evaluating a time delay in a mobile video, comprising:
matching a data packet in a first collection point with a data packet in a second collection point, wherein the first collection point and/or the second collection point divides a transmission path of a service flow containing the data packet into at least two segments; and
calculating, if the data packet in the first collection point and the data packet in the second collection point are matched, the time delay in the service flow of the data packet between the first collection point and the second collection point.

2. The method according to claim 1, further comprising: the data packet in the first collection point and the data packet in the second collection point are both video data packets;
wherein matching a data packet in a first collection point with a data packet in a second collection point comprises: extracting an identity field of the video data packet in the first collection point;
taking the identity field of the video data packet in the first collection point as a keyword to compare with an identity field of the video data packet in the second collection point;
determining if the data packet in the first collection point and the data packet in the second collection point are matched comprises:
determining that the video data packet in the first collection point and the video data packet in the second collection point are matched if an identity field of the video data packet in the first collection point is identical with an identity field of the video data packet in the second collection point.

3. The method according to claim 1, further comprising: the data packet in the first collection point is a video data packet, and the data packet in the second collection point is an audio-video mixed data packet;
wherein matching a data packet in a first collection point with a data packet in a second collection point comprises:
extracting a plurality of bytes from a payload of the video data packet in the first collection point;
taking the plurality of bytes of the payload of the video data packet in the first collection point as keywords to query in the audio-video mixed data packet in the second collection point;
determining if the data packet in the first collection point and the data packet in the second collection point are matched comprises:
determining that the data packet in the first collection point and the data packet in the second collection point are matched if a plurality of bytes are found in a payload of the data packet in the second collection point, wherein the plurality of bytes from the payload of the data packet in the second collection point are identical with the plurality of bytes of the payload of the data packet in the first collection point.

4. The method according to claim 1, further comprising: the data packet in the first collection point is a video data packet, and the data packet in the second collection point is an audio-video mixed data packet; wherein matching a data packet in a first collection point with a data packet in a second collection point comprises:
extracting a plurality of bytes from a payload of the video data packet in the first collection point;
executing a bit inversion for each of the plurality of bytes of the payload of the video data packet in the first collection point to obtain a plurality of new bytes of the payload of the video data packet in the first collection point;
taking the plurality of new bytes of the payload of the video data packet in the first collection point as keywords to query in the audio-video mixed data packet in the second collection point;
determining if the data packet in the first collection point and the data packet in the second collection point are matched comprises:
determining that the video data packet in the first collection point and the audio-video mixed data packet in the second collection point are matched if a plurality of bytes are found in a payload of the audio-video mixed data packet in the second collection point, wherein the plurality of bytes from the payload of the audio-video mixed data packet in the second collection point are identical with the plurality of new bytes of the payload of the video data packet in the first collection point.

5. The method according to claim 1, wherein calculating the time delay in the service flow containing the data packet between the first collection point and the second collection point comprises:
obtaining a time at which the data packet in the first collection point first undergoes the first collection point and a time at which the data packet in the second collection point first undergoes the second collection point; and
calculating a time difference between the time at which the data packet in the first collection point first undergoes the first collection point and the time at which the data packet in the second collection point first undergoes the second collection point, to obtain the time delay in the service flow containing the data packet between the first collection point and the second collection point.

6. The method according to claim 2, wherein calculating the time delay in the service flow containing the data packet between the first collection point and the second collection point comprises:
obtaining a time at which the data packet in the first collection point first undergoes the first collection point and a time at which the data packet in the second collection point first undergoes the second collection point; and
calculating a time difference between the time at which the data packet in the first collection point first undergoes the first collection point and the time at which the data packet in the second collection point first undergoes the second collection point, to obtain the time delay in the service flow containing the data packet between the first collection point and the second collection point.

7. The method according to claim 3, wherein calculating the time delay in the service flow containing the data packet between the first collection point and the second collection point comprises:
obtaining a time at which the data packet in the first collection point first undergoes the first collection point and a time at which the data packet in the second collection point first undergoes the second collection point; and
calculating a time difference between the time at which the data packet in the first collection point first undergoes the first collection point and the time at which the data packet in the second collection point first undergoes the second collection point, to obtain the time delay in the service flow containing the data packet between the first collection point and the second collection point.

8. The method according to claim 4, wherein calculating the time delay in the service flow containing the data packet between the first collection point and the second collection point comprises:
obtaining a time at which the data packet in the first collection point first undergoes the first collection point and a time at which the data packet in the second collection point first undergoes the second collection point; and
calculating a time difference between the time at which the data packet in the first collection point first undergoes the first collection point and the time at which the data packet in the second collection point first undergoes the second collection point, to obtain the time delay in the service flow containing the data packet between the first collection point and the second collection point.

9. The method according to claim 1, further comprising, after calculating the time delay in the service flow containing the data packet between the first collection point and the second collection point:
making statistics about the time delay in the service flow containing the data packet between each of the collection points.

10. The method according to claim 1, further comprising, before matching the data packet in a first collection point with the data packet in a second collection point:
collecting data in a packet switch domain collection point to obtain the data packet; or
collecting data in a packet switch domain collection point and a circuit switch domain collection point to obtain the data packet.

11. The method according to claim 10, wherein collecting data in a packet switch domain collection point and a circuit switch domain collection point to obtain the data packet further comprises:
parsing the data collected in the circuit switch domain collection point, to obtain the data packet identified by an upper layer protocol.

12. An apparatus for evaluating a time delay in a mobile video service, comprising:
a matching module, for matching a data packet in a first collection point with a data packet in a second collection point, wherein the first collection point and/or the second collection point divides a transmission path of a service flow containing the data packet into at least two segments; and
a time delay calculating module, for calculating the time delay in the service flow containing the data packet between the first collection point and the second collection point, when a matching result of the matching module shows that the data packet in the first collection point and the data packet in the second collection point matches.

13. The apparatus according to claim 12, wherein, the data packet in the first collection point and the data packet in the second collection point are both video data packets, the matching module comprises:
a first extracting unit, configured to extract an identity field of the video data packet in the first collection point;
a first comparing unit, configured to take the identity field of the video data packet in the first collection point as a keyword to compare with an identity field of the video data packet in the second collection point; and
a first determining unit, configured to determine that the video data packet in the first collection point and the video data packet in the second collection point matches if the identity field of the video data packet in the first collection point is identical with the identity field of the video data packet in the second collection point.

14. The apparatus according to claim 12, wherein the data packet in the first collection point is a video data packet and the data packet in the second collection point is an audio-video mixed data packet, the matching module comprises:
a second extracting unit, configured to extract a plurality of bytes from a payload of the video data packet in the first collection point;
a second querying unit, configured to take the plurality of bytes from the payload of the video data packet in the first collection point as keywords to query in the audio-video mixed data packet in the second collection point; and
a second determining unit, configured to determine that the video data packet in the first collection point and the audio-video mixed data packet in the second collection point matches if a plurality of bytes are found in a payload of the audio-video mixed data packet in the second collection point, wherein the plurality of bytes of the payload of the audio-video mixed data packet in the second collection point are identical with the plurality of bytes of the payload of the video data packet in the first collection point.

15. The apparatus according to claim 14, wherein the matching module further comprises:
a converting unit, configured to execute a bit inversion for each of the plurality of bytes of the payload of the video data packet in the first collection point to obtain a plurality of new bytes of the payload of the video data packet in the first collection point; wherein:
the second determining unit is further configured to determine that the video data packet in the first collection point and the audio-video mixed data packet in the second collection point matches if a plurality of bytes are found in a payload of the audio-video mixed data packet in the second collection point, wherein the plurality of bytes of the payload of the audio-video mixed data packet in the second collection point are identical with the plurality of new bytes of the payload of the video data packet in the first collection point.

16. The apparatus according to claim 12, further comprising:
a statistical module, configured to making statistics about the time delay in the service flow containing the data packet between each of the collection points.

17. The apparatus according to claim 12, further comprising:
a circuit switch domain data collecting module, for collecting data in a circuit switch domain collection point to obtain the data packet.

18. The apparatus according to claim 17, further comprising:
a parsing module, for parsing the data collected by the circuit switch domain data collecting module in the circuit switch domain collection point, to obtain the data packet identified by an upper layer protocol.
